(19) United States
(12) Patent Application Publication
(10) Pub. No.: US 2019/0024927 A1
(43) Pub. Date: Jan. 24, 2019

(54) AIR CONDITIONING SYSTEM FOR A BUILDING HAVING CONTROL BOX RECEIVING ORDERS TO CURTAIL CONSUMPTION OF ELECTRICITY FROM EXTERNAL AGGREGATOR

(71) Applicant: SOLUTIONS ENERGIES NOUV RENOUVELABLES, La Baule Escoublac (FR)

(72) Inventors: Jean Noel Mahe, La Baule (FR); Patrice Aubin, Vendargues (FR)

(21) Appl. No.: 16/069,425

(22) PCT Filed: Sep. 26, 2016
(86) PCT No.: PCT/FR2016/052439

§ 371 Date: Jul. 11, 2018

(30) Foreign Application Priority Data
Jan. 13, 2016 (FR) 1650243

(51) Int. Cl. F24F 11/46; F24F 11/56; F24F 11/64; F24F 11/65; F24F 11/88; G05B 19/042

(52) U.S. Cl. CPC F24F 11/46; F24F 11/56; F24F 11/64; F24F 2110/10; F24F 11/88; G05B 19/042; F24F 11/65

(57) ABSTRACT

A building air conditioning system, which includes electricity sources; an electricity management system; an air conditioner for the building; and a control and management system. The control and management system includes a control box located in the building, the control box including programming keeping the building at a set temperature and to select electricity sources. The system further includes an external aggregator for energy management of a public energy distribution network. The control box has a module for communication with the external aggregator and capable of receiving priority set values from the external aggregator.

### CROSS-REFERENCE TO RELATED APPLICATIONS

This Application is a Section 371 National Stage Application of International Application No. PCT/FR2016/052439, filed Sep. 26, 2016, the content of which is incorporated herein by reference in its entirety, and published as WO 2017/121929 on Jul. 20, 2017, not in English.

### FIELD OF THE DISCLOSURE

The domain of the invention is the design of air conditioning systems for buildings. More precisely, the invention relates to a building air conditioning system designed to be integrated into a public electricity network in which electricity generation has to be rationalised.

### BACKGROUND OF THE DISCLOSURE

Classically, building air conditioning systems are known composed of at least one air conditioning unit outside the building and at least one air conditioning unit inside the building, designed to cooperate so as to heat or to cool the building.

In general, there are temperature sensors in each room in the building in which an air conditioning unit is installed inside the building.

These temperature sensors then cooperate with a single control device in the building or with several control devices located in each room in which an internal air conditioning unit is installed. These control devices are programmed so as to start functioning of internal and external air conditioning units to keep the building, or each room, at a temperature predetermined by an operator (a person inside the room or a building manager).

Nevertheless, these air conditioning systems are energy-greedy systems. The electricity consumption of a building equipped with an air conditioning system is impacted during operation of this system.

This increase in electricity consumption is even more problematic in the case in which electricity procured from a public electricity distribution network is limited or is subject to production uncertainties.

For example, mention can be made of public electricity networks supplied by wind turbines when there is insufficient wind to generate electricity or when low or high temperatures trigger operation of air conditioning systems.

Mention can also be made of the example of public electricity distribution networks dependent on nuclear energy during heat waves. Heat waves can cause a reduction in electricity production to avoid overheating nuclear power stations, and an increase in electricity consumption due to air conditioning systems.

The electricity consumption of air conditioning systems also causes problems with operating costs. Periods during which these air conditioning systems are used may correspond to periods during which the cost of electricity from a public electricity distribution network is high.

### SUMMARY

One particular purpose of this invention is to overcome these disadvantages of prior art.

More precisely, the purpose of the invention is to disclose a building air conditioning system that is adapted to be connected to a public electricity distribution network in which electricity consumption has to be rationalised.

Another purpose of the invention is to disclose such an air conditioning system that is adapted to electricity production uncertainties.

Another purpose of the invention is to disclose such a system that is more economic for its owner to implement that is possible in prior art.

These objectives, and others that will become clear later, are achieved as a result of the invention related to a building air conditioning system, the system comprising:
electricity sources comprising a public electricity distribution network and at least one other alternative source;
electricity management means provided by electricity sources, these management means being intended to centralise electricity form the different sources and to distribute electricity originating from at least one selected source;
building air conditioning means;
control and management means, combined with the electricity management means and air conditioning means, these control and management means comprising a control box to be located in the building, the control box comprising:
   means of inputting a minimum and/or maximum set temperature;
   programming designed to keep the building at said set temperature,
      characterised in that the control box is programmed to select one and/or the other electricity source,
      and in that the system comprises an external aggregator for management of energy from the public electricity distribution network, comprising means of input and output of priority set values for reduction of electricity consumption, and in that the control box comprises a module for communication with the external aggregator capable of receiving priority set values from the aggregator, the communication module being combined with a processor in the control box programmed to force replacement of the minimum set value and/or the maximum set value by priority set values, in the programming.

The system according to the invention can thus be used to “curtail the electricity consumption”. Curtailment of the electricity consumption consists of temporarily reducing the electricity consumption of a customer of an electricity distribution network in the case of a mismatch between electricity production and consumption. This curtailment more specifically affects the building air conditioning system.

Advantageously, the alternative sources include photovoltaic panels, and settings of the control box programming are modified to select the alternative sources in priority.

The air conditioning system according to the invention can thus reduce the building electricity demand from the public electricity distribution network. Consequently, the air conditioning system is more economic to use in the long term, particularly if the cost of purchasing electricity from the public electricity distribution network is high.

According to one preferred embodiment, the alternative sources comprise electricity accumulators designed to supplement electricity needs in case of intermittent production from photovoltaic panels, and the electricity management means recharge the electrical accumulators in the case in which the photovoltaic panels generate more electricity than necessary for electricity consumption of the building.

Such an embodiment gives further priority to consumption of electricity generated by the photovoltaic panels of the building. Electricity needs from the public electricity distribution network to supply power to air conditioning means are further reduced.

Preferably, the electrical accumulators are made of LiFePO₄.

Such accumulators are particularly suitable for compensating a sudden drop of electricity production from photovoltaic panels because they are capable of supplying high power outputs very quickly.

According to one advantageous solution, the control and management means include computer monitoring and input means to be located in the building, coupled to the control box through a remote connection module of the control box.

These computer monitoring and input means may consist of computers provided with a program or an internet interface designed specifically for the air conditioning system. They make it easy to take control over the air conditioning system and to modify the operating parameters of the air conditioning system.

Preferably, the control and management means include computer supervision means to be located outside the building, coupled to the control box through the remote connection module.

Such supervision that can be performed from a distance enables the building occupant or the air conditioning system installer to take control. This remote supervision can be used to maintain good operation of the air conditioning system or to make modifications to operation of the installation.

### BRIEF DESCRIPTION OF THE DRAWINGS

Other characteristics and advantages of the invention will become clearer after reading the following description of one preferred embodiment of the invention given as an illustrative and non-limitative example, and the appended drawings among which:

FIG. 1 is a diagrammatic view of the building air conditioning system according to the invention.

FIG. 2 is a diagrammatic view of a control box for a building air conditioning system according to the invention,

### DETAILED DESCRIPTION OF ILLUSTRATIVE EMBODIMENTS

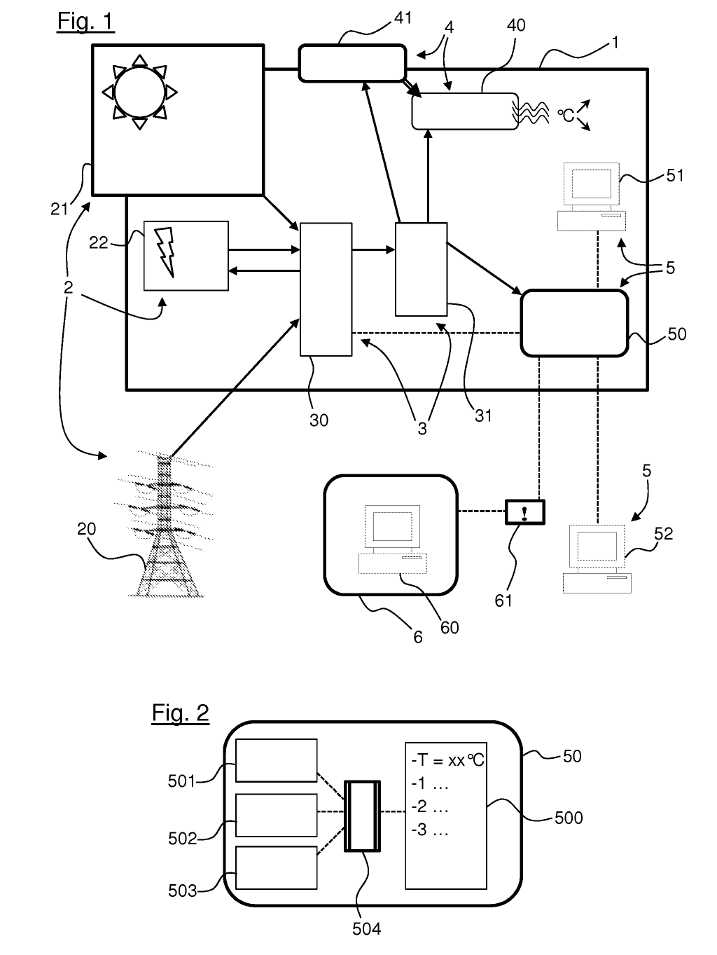

As can be seen on FIG. 1, the air conditioning system according to the invention is intended to air condition a building 1.

This air conditioning system comprises:
electricity sources 2;
electricity management means 3;
air conditioning means 4 for the building 1;
control and management means 5 coupled with electricity management means and air conditioning means.

There are multiple electricity sources 2 including:
a public electricity distribution network 20;
alternative sources specific to the building and independent of the public network, comprising:
   photovoltaic panels 21;
   electrical accumulators 22, preferably made of LiFePO₄.

The electrical accumulators 22 supplement electricity needs of the system in the case of intermittent production from photovoltaic panels and/or intermittent procurement of electricity from the public electricity distribution network.

The electricity management means 3 manage electricity supplied by the electricity sources 2. They can centralise electricity originating from sources, select at least one of these sources and distribute electricity from the previously selected source(s).

More precisely, the electricity management means 3 consist of a smoothing cabinet 30 and a low voltage main switchboard 31.

The objectives of the smoothing cabinet are to receive electricity from sources, to transform electricity and inject it into the low voltage main switchboard and/or into the electrical accumulators and/or into the public electricity distribution network.

The electricity management means 3 are designed to recharge the electrical accumulators with surplus electricity production from the photovoltaic panels, in other words when the photovoltaic panels produce more electricity than is consumed by the building. In the case in which the electrical accumulators are charged and the photovoltaic panels are still generating more electricity than is consumed by the building, the surplus electricity can be injected into the public electricity distribution network.

The objectives of the low voltage main switchboard are to receive electricity from the smoothing cabinet, to protect electrical devices powered by the management means, distribute electricity and supply electricity to these electrical devices.

The air conditioning means comprise at least one external air conditioning unit 41 and at least one internal air conditioning unit 40. These air conditioning units are supplied with electricity through the low voltage main switchboard 31.

The external air conditioning unit 41 is a compression cooling machine that supplies heat energy to the internal air conditioning unit 40, that can cool or heat the building 1.

The air conditioning system according to the invention also comprises an external aggregator 6 for energy management of the public energy distribution network.

The purpose of this aggregator is to manage requests to curtail consumption of electricity from the public electricity distribution network 20 during electricity consumption peaks or when production drops. To respond to these curtailment requests, the external aggregator 6 comprises means of inputting and outputting set values for reduction of electricity consumption 60. Such set values for reduction of electricity consumption form priority set values 61 for the system.

These set values for reduction of electricity consumption can consist of a maximum value of electricity consumption to be reached, or a percentage reduction of the electricity consumption to be reached.

As can be seen on FIG. 1, the means 5 of control and management of the air conditioning system according to the invention comprise:
a control box 50 located in the building 1;
computer monitoring and input means 51 coupled to the control box and located in the building;
computer supervision means 52 coupled to the box and located outside the building;

The control box is a device that sets up a link between the different components of the system. Communication to the air conditioning means takes place by a data exchange following either a principle of direct communication, or a principal of communication using a generic communication protocol in building management.

According to this embodiment and as can be seen on FIG. 2, this control box comprises:
programming 500 designed to keep the building at a minimum and/or a maximum set temperature,
means of inputting a minimum and/or a maximum set temperature 501;
a module 502 for communication with the external aggregator;
a remote control module 503;
a processor 504.

The control box controls firstly the electrical power supply to the air conditioning system, and secondly the temperature regulation of the building. For the temperature regulation, the minimum and/or maximum set temperature input means can be used to enter a temperature to which the building must be cooled or heated directly on the control box.

Firstly, the programming is designed such that the control box selects one and/or the other of the electricity sources based on a predetermined preference criterion. In fact, the programming 500 of the control box 50 is configured to select the alternative sources in priority, therefore to select the photovoltaic panels or the electrical accumulators in priority over the public electricity distribution network.

Secondly, the communication module is coupled with the control box processor that is programmed to force replacement of the programmed maximum and/or minimum set temperature by priority set values 61, when these priority set values were output by the external aggregator and received by the communication module.

There can be several special features to programming 500 of the control box 50. The programming can include the assignment of internal air conditioning units to priority groups.

According to one example application, these groups may be as follows:
group A: non-priority units;
group B: first level priority units;
group C: second level priority units;
group D: absolute priority units.

These internal air conditioning units are assigned to these groups when the system is put into service, and obviously it remains possible to change the group to which units belong later.

The programming also includes parameters defining a regulation type (economy, comfort, fixed) and a threshold corresponding to an energy economy coefficient (defined relative to the nominal consumption of external air conditioning units).

Thus, during normal operation of the air conditioning system, the control box compares the electricity consumption of the air conditioning system, the production of electricity by photovoltaic panels and programming parameters. In order to reach the target defined by the parameters (regulation type and threshold), the control box will act on the internal air conditioning units (switching off, reduction of the heating temperature, increase in the air conditioning temperature, etc.) to reduce the electricity consumption of the external air conditioning units.

Groups make it possible to modulate the impact of the parameters. Thus, if a drop in consumption is necessary, the control box acts firstly on group A, then on group B, and finally on group C. Group D will never be impacted, for example it may comprise internal air conditioning units located in rooms in which the temperature must absolutely remain below or above a given temperature, or at a constant temperature.

Moreover, in the case of a priority set value output from the external aggregator, the control box acts on the air conditioning means in a similar manner to that explained above, so that the electricity consumption of the air conditioning system reaches the new target fixed by the priority set value.

In other words, programming of the control box can be as follows:
heat an office and a corridor to maintain a minimum temperature of 21° C. during the day and a minimum temperature of 15° C. at night;
cool a computer room to keep a constant 22° C.

If electricity production by the photovoltaic panels reduces during the day, the programming can switch off the internal air conditioning unit located in the corridor, to give priority to maintaining the temperature in the office.

In addition, if the control box receives a priority set value from the external aggregator, it may need to order deactivation of internal air conditioning units, except for the unit located in the computer room (this room having absolute priority so as to not damage the computer equipment located inside this room).

The remote connection module enables the control box to be coupled to computer monitoring and input means and to the supervision means, as illustrated on FIG. 1.

The computer monitoring and input means 51 and the computer supervision means 52 consist particularly of electronic devices such as computers or electronic tablets.

A person located in the building can then use the computer monitoring and input means to:
be familiar with temperature readings in rooms in the building in which temperature sensors and internal air conditioning units are installed;
know temperature settings;
modify the building set temperature.

Such computer monitoring and input means make it easy to access data and settings of the air conditioning system according to the invention. For example, the installer of the air conditioning system can control the system through the computerised supervision means so as to perform a maintenance operation.

More precisely, this remote control using an electronic device (computer, electronic tablet, etc.) can take place through a web application capable of communicating with the control box using the remote connection module.

Finally, the control box can be made directly controllable on site through display and manipulation means (for example using a touch screen) connected to the box. Although the present disclosure has been described with reference to one or more examples, workers skilled in the art will recognize that changes may be made in form and detail without departing from the scope of the disclosure and/or the appended claims.

1. A building air conditioning system, the system comprising:
electricity sources comprising an electricity input from a public electricity distribution network and at least one other alternative source;
means for management of electricity provided by the electricity sources, the management means centralizing electricity form from difference ones of the electricity sources and distributing electricity originating from at least a selected one of the electricity sources;
an air conditioner for the building;
control and management means, combined with the electricity management means and air conditioner, the control and management means comprising a control box configured to be located in the building, the control box comprising:
an input for inputting a minimum and/or a maximum set temperature;
programming designed to keep the building at said set temperature,
wherein the control box is programmed to select at least one of the electricity sources,
and wherein the system comprises an external aggregator for management of energy from the public electricity distribution network received through the electricity input, comprising means of input and output of priority set values for reduction of electricity consumption,
and wherein the control box comprises a module for communication with the external aggregator capable of receiving the priority set values from the aggregator, the communication module being combined with a processor in the control box programmed to force replacement of the minimum set value and/or the maximum set value by the priority set values, in the programming.

2. The building air conditioning system according to claim 1, wherein the at least one alternative source includes photovoltaic panels,
and wherein the programming of the control box is configured to select the at least one alternative source in priority.

3. The building air conditioning system according to claim 2, wherein the at least one alternative source comprises electricity accumulators designed to supplement electricity needs in case of intermittent production from the photovoltaic panels, and wherein the electricity management means recharge the electrical accumulators in the case in which the photovoltaic panels generate more electricity than necessary for electricity consumption of the building.

4. The building air conditioning system according to claim 3, wherein the electrical accumulators are made of LiFePO₄.

5. The building air conditioning system according to claim 1, wherein the control and management means include computer monitoring and input means to be located in the building, coupled to the control box through a remote connection module of the control box.

6. The building air conditioning system according to claim 5, wherein the control and management means include computer supervision means to be located outside the building, coupled to the control box through the remote connection module.
